(19) United States
(12) Patent Application Publication
(10) Pub. No.: US 2015/0134416 A1
(43) Pub. Date: May 14, 2015

(54) INITIAL MARKETING CAMPAIGN TARGETS

(71) Applicant: INTERNATIONAL BUSINESS MACHINES CORPORATION, Armonk, NY (US)

(72) Inventor: Natwar Modani, Haryana (IN)

(73) Assignee: INTERNATIONAL BUSINESS MACHINES CORPORATION, Armonk, NY (US)

(21) Appl. No.: 14/076,679

(22) Filed: Nov. 11, 2013

(51) Int. Cl. G06Q 30/02; G06Q 50/00

(52) U.S. Cl. CPC G06Q 30/0204; G06Q 50/01
USPC 705/7.33

(57) ABSTRACT

A method and system for determining marketing targets is provided. The method includes a customer list comprising a population of potential customers for a product or service. The potential customers are divided into groups of social communities and specified effort criteria associated with the groups of social communities with respect to the product or service are determined. Each specified effort criteria is associated with an associated group of the groups of social communities with respect to the product or service. Specified customers from each group are selected based on each specified effort criteria.

### FIELD

The present invention relates generally to a method for determining marketing targets, and in particular to a method and associated system for determining initial targets for a viral marketing campaign.

### BACKGROUND

Methods for determining a sales approach typically includes an inaccurate process with little flexibility. Associating a sales approach with specified individuals may include a complicated process that may be time consuming and require a large amount of resources. Accordingly, there exists a need in the art to overcome at least some of the deficiencies and limitations described herein above.

### SUMMARY

A first aspect of the invention provides a method comprising: receiving, by a computer processor of a computing system, a customer list comprising a population of potential customers for a product or service; dividing, by the computer processor, the potential customers into groups of social communities; determining, by the computer processor, specified effort criteria associated with the groups of social communities with respect to the product or service; associating, by the computer processor based on inspection data received from expert individuals with respect to inspecting the social communities, each specified effort criteria with an associated group of the groups of social communities with respect to the product or service; and selecting, by the computer processor based on each specified effort criteria, specified customers from each group of the groups of social communities.

A second aspect of the invention provides a computing system comprising a computer processor coupled to a computer-readable memory unit, the memory unit comprising instructions that when executed by the computer processor implements a method comprising: receiving, by the computer processor, a customer list comprising a population of potential customers for a product or service; dividing, by the computer processor, the potential customers into groups of social communities; determining, by the computer processor, specified effort criteria associated with the groups of social communities with respect to the product or service; associating, by the computer processor based on inspection data received from expert individuals with respect to inspecting the social communities, each specified effort criteria with an associated group of the groups of social communities with respect to the product or service; and selecting, by the computer processor based on each specified effort criteria, specified customers from each group of the groups of social communities.

A third aspect of the invention provides a computer program product, comprising a computer readable hardware storage device storing a computer readable program code, the computer readable program code comprising an algorithm that when executed by a computer processor of a computer system implements a method, the method comprising: receiving, by the computer processor, a customer list comprising a population of potential customers for a product or service; dividing, by the computer processor, the potential customers into groups of social communities; determining, by the computer processor, specified effort criteria associated with the groups of social communities with respect to the product or service; associating, by the computer processor based on inspection data received from expert individuals with respect to inspecting the social communities, each specified effort criteria with an associated group of the groups of social communities with respect to the product or service; and selecting, by the computer processor based on each specified effort criteria, specified customers from each group of the groups of social communities.

The present invention advantageously provides a simple method and associated system capable of determining a sales approach.

### BRIEF DESCRIPTION OF THE DRAWINGS

FIG. 1 illustrates a system for determining initial marketing campaign targets, in accordance with embodiments of the present invention.

FIG. 2 illustrates an algorithm detailing a process flow enabled by the system of FIG. 1 for determining initial marketing campaign targets, in accordance with embodiments of the present invention.

FIGS. 3A-3E illustrate a screen shot enabled by the system of FIG. 1 for summarizing like-minded communities, in accordance with embodiments of the present invention.

FIG. 4 illustrates a screen shot enabled by the system of FIG. 1 for creating a new campaign, in accordance with embodiments of the present invention.

FIG. 5 illustrates a screen shot enabled by the system of FIG. 1 for altering a target allocation, in accordance with embodiments of the present invention.

FIG. 6 illustrates a block diagram 600 depicting a process for locating similar (like-minded) communities, in accordance with embodiments of the present invention.

FIG. 7 illustrates a graphical view of similar communities, in accordance with embodiments of the present invention.

FIG. 8 illustrates a computer apparatus used by the system of FIG. 1 for determining initial marketing campaign targets, in accordance with embodiments of the present invention.

### DETAILED DESCRIPTION

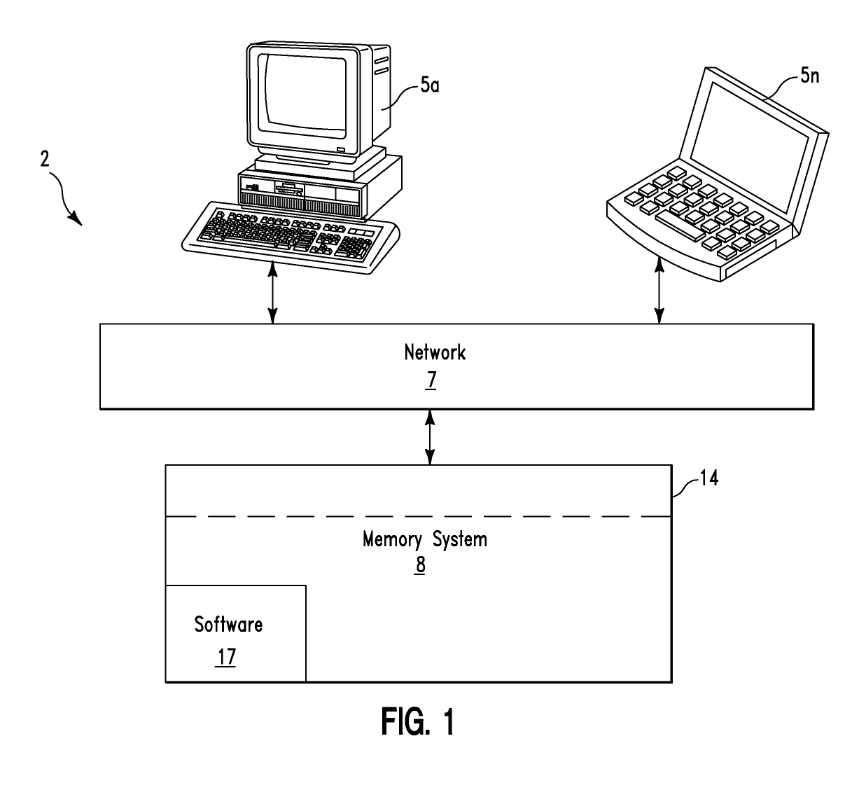

FIG. 1 illustrates a system 2 for determining initial marketing campaign targets, in accordance with embodiments of the present invention. System 100 enables a method for implementing a viral marketing campaign for promoting a product (or service) via a “word of mouth” process. An individual that is targeted to receive a viral marketing campaign may virally infect associated social contacts. System 2 performs the following functions:

1. Dividing the potential customers into communities.
2. Determining an amount of effort to spend on each community of potential customers.
3. Selecting appropriate potential customers from each community based on a limited effort for spending on each community.

System 2 of FIG. 1 includes computers 5a . . . 5n connected through a network 7 to a computing system 14. Network 7 may include any type of network including, inter alia, a local area network, (LAN), a wide area network (WAN), the Internet, a wireless network, etc. Computers 5a . . . 5n may include any type of computing system(s) including, inter alia, a computer (PC), a laptop computer, a tablet computer, a server, a PDA, a smart phone, etc. Computing system 14 may include any type of computing system(s) including, inter alia, a computer (PC), a laptop computer, a tablet computer, a server, etc. Computing system 14 includes a memory system 8. Memory system 8 may include a single memory system. Alternatively, memory system 8 may include a plurality of memory systems. Memory system 8 includes software 17.

System 2 executing software 17 to execute a four step process for determining viral marketing targets as follows:

1. Divide an entire population into groups of people (i.e., communities).
2. Determine a portion of a budget for use (in terms of number of people to target or money to spend) with respect to each of the groups.
3. Allow a marketer to change a budget allocation on a per community basis.
4. Determines specified people within the groups with a given budget constraint (at a group level).

System 2 identifies a correct set of people to target (for a marketing campaign) from a given population. Initially, system 2 determines communities from social interaction data. Past purchase data may be used to locate similar (e.g., like-minded) communities. Similar communities are defined herein as groups of people having a high degree of social interaction with each other. Additionally, similar communities have a high degree of similarity in past purchases/interests. System 2 additionally computes characteristics associated with the similar communities. Characteristics may include a size of the communities (in terms of a number of people), a level of similarity (e.g., if past purchase data is available), a profitability and resistance threshold of the communities, etc.

System 2 computes similarities of a community as follows:

1. Define a pair-wise similarity of people as a cosine similarity between purchase histories/ratings.
2. Define community similarities as an average similarity between all pairs in the community.

System 2 computes profitability based on a past profitability from previous transactions.

System 2 computes a resistance threshold. A resistance threshold is defined herein as a product comprising a high spread or a quick spread within a community. Based on the aforementioned characteristics, system 2 computes a budget allocation for the communities. A budget computation may be performed as follows: A score is assigned to each community based on a non-decreasing function of the characteristics mentioned earlier. For example, if 100<size<200 and profitability>$100 per person and a resistance threshold<20, then pick 20 targets from this community.

System 2 selects individuals from communities. Within a group, a set of individuals are selected based on:

1. Activity levels of community members.
2. Roles and reach of the individuals in the community.
3. A budget required for targeting community members
4. An expected profit from community members.

System 2 provides a framework for selecting individuals as a reward collection problem (RCP). A greedy algorithm comprises a valid approximation algorithm for executing an RCP. Determining an RCP is described with respect to the following example and based on the following input factors:

1. An agency selling an item.
2. A population comprising potential buyers (comprising available finances for purchase) of the item. The available finances are defined as rewards. Some potential buyers have an influence on other potential buyers. A degree of influence varies from pair to pair. The agency may hire some potential buyers, so that they may influence others to give part of the money they have to the agency.

An RCP may be defined in graph theoretic terminology as described as follows:

Let G=(V, E) equal a graph with vertices V and edges E. Each of the edges are weighted, and let the weight of each edge from vertex u to v be wᵤᵥ, 0<=wᵤᵥ<=1. An interpretation of the edge weight is such that if node u is targeted (hired), it would be able to retrieve wᵤᵥ fraction of the reward currently available with vertex v. Additionally, let cᵥ comprise a cost of targeting vertex v and rᵥ comprise a reward available with vertex v. Furthermore, let an external agency comprise a budget of B. An objective for the external agency comprises targeting a set of vertices T, such that the cost of targeting the vertices in T is bounded by B and the reward obtained by the agency is maximized. Let the agency's decision to hire a person vᵢ be denoted by dᵢ, such that dᵢ=1 if the agency hires person vᵢ and dᵢ=0 if the agency does not hire person vᵢ. Therefore, a reward that resides with person vⱼ comprises residual(j)=rⱼ*Product_{i=1}̂{V|}(1−dᵢ*wᵢⱼ) and a total residual reward (across all people) comprises residual=Sum_{j=1}̂{|V|}rⱼ*Product_{i=1}̂{|V|} (1−dᵢ*wᵢⱼ). Additionally, a reward collected by the agency comprises R=\Sum {j=1}̂{|V|}rⱼ*(1−Product_{i=1}̂{|V|}(1−dᵢ*wᵢⱼ)). Based on the previous calculations, the agency may maximize \Sum_{j=1}̂{|V|}rⱼ*(1−\Product_{i=1}̂{|V|} (1−dᵢ*wᵢⱼ)) such that \Sum_{i=1}̂{|V|} (dᵢ*cᵢ)<=B. Additionally, the objective may be rephrased as minimizing a residual reward with the vertices V, which generates a better formulation for RCP resulting in minimize \Sum_{—} {j=1}̂{|V|rⱼ}*(\Product_{i=1}̂{|V|} (1−dᵢ*wᵢⱼ)) such that \Sum_{i=1}̂{|V|} (dᵢ*cᵢ)<=B.

A reward rᵥ associated with a vertex v may be estimated based on the purchases made by the vertex v associated with mining prior purchases. A cost cᵥ of targeting the vertex v is based on a determined offer for vertex v. Additionally, weights associated with edges may be estimated by the strength of a communication or influence of one on the other. The weights are additionally expected to factor in indirect effects. For example, if a basic direct influence graph is given, an influence may be derived by taking it as sum of all paths (weighted by their length) between a pair. A weight may also factor in if the two nodes are in a same community, communicate directly, or any combination thereof.

A greedy algorithm for determining RCP for a single community, extension to multiple communities is described by the algorithm as follows:

```
Given: A graph G(V,E(W)), rewards R, costs C, and budget B.
init: available vertices U = V, residual budget b=B, solution set S = { }
      while(b >= min(cᵢ: vᵢ \in U) && |U| > 0)
            for all vᵢ \in U
                  s(vᵢ,G) = \sum_{j=1}\hat{ }|V| rⱼ * wᵢⱼ
            end for
            x = argmax_{v \in U, cᵥ <= b} (s(v,g) / cᵥ)
            S = S \Union {x}
            U = U − {x}
            b = b − cᵢ
            for all vᵢ \in U
                  rⱼ = rⱼ * (1−wₓᵢ)
            end for
        end while.
```

Alternatively (with respect to determining an RCP), individuals may be selected based on a scoring function defined on vertex KPIs (including an activity level of an individual and a role/reach in the community). The scoring function comprises a non-decreasing function with respect to two specified KPIs. As another alternative, a data mining based model (on similar KPIs) may be implemented to determine if a customer comprises a good target.

System 2 performs the following method for selecting targets for a viral marketing campaign:

1. Dividing potential customers into communities.
2. Determining how much effort to spend on each community.
3. Allowing a human expert to inspect and modify system recommended effort allocation with respect to communities.
4. Selecting potential customers from each community based on limited effort for spending on the community.

System 2 performs the following method for automatically determining an effort to be allocated to each community:

1. Retrieving an overall effort budget (for the entire population) and a division of people in communities as input.
2. Computing an allocation to a community based on attributes (e.g., size, density, like-mindedness, previous purchases, average interaction level, etc.) of the community.
3. Adjusting an allocation such that the allocation comprises at least as much as resistance threshold while still maintaining the overall budget constraint.

System 2 performs the following method for determining a set of people to target from within a community given a budget for the community:

1. Associating a measure of influence (or strength of connection) of an individual on another (for every edge in a graph).
2. Associating a notion of reward with each individual.
3. Determining a gain by targeting each individual in the community that has not been targeted yet, by adding the remaining reward from the individual, as well as the gain from connected individuals. The gain from connected individuals is calculated is based on the multiplication of influence and remaining rewards associated with the connected individual.
4. Selecting an individual comprising a highest gain, reducing the budget, and reducing the rewards associated with individuals connected to a selected individual.

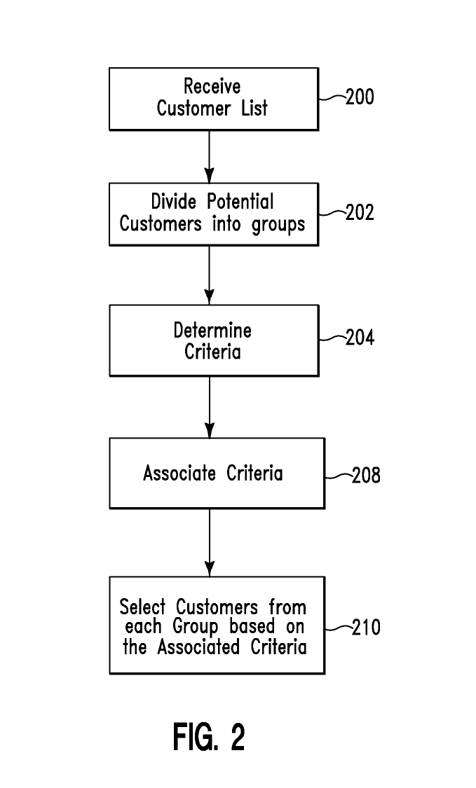

FIG. 2 illustrates an algorithm detailing a process flow enabled by system 2 of FIG. 1 for determining initial marketing campaign targets, in accordance with embodiments of the present invention. Each of the steps in the algorithm of FIG. 2 may be enabled and executed in any order by a computer processor executing computer code. In step 200, a customer list comprising a population of potential customers for a product or service is received. In step 202, the potential customers are divided into groups of social communities (i.e., comprising similar traits). In step 204, specified effort criteria (associated with the groups of social communities with respect to product or service) are determined. The specified effort criteria may be measured in terms of a number of potential customers for targeting and an amount of a promotion budget allocated to the potential customers. Determining the specified effort criteria may include:

1. Receiving effort budget data and customer data associated with the potential customers.
2. Allocating the potential customers into groups of social communities based on specified attributes of the social communities.
3. Modifying the allocation with respect to a resistance threshold and the effort budget data.

The specified attributes may include, inter alia, size attributes, density attributes, like-mindedness attributes, purchase attributes, interaction level attributes, etc.

In step 208, each specified effort criteria is associated with (based on inspection data received from expert individuals with respect to inspecting the social communities) an associated group of social communities with respect to the product or service. In step 210, specified customers from each group are selected based on each specified effort criteria. Selecting the specified customers may include:

1. Associating a measure of influence associated with specified customers with respect to each other.
2. Associating rewards with each customer of the specified customers.
3. Determining, based on the rewards, gain factors for the specified customers.
4. Selecting a customer of associated with a highest gain factor.
5. Adjusting, based on an influence of the customer, first awards of associated with the first customer.

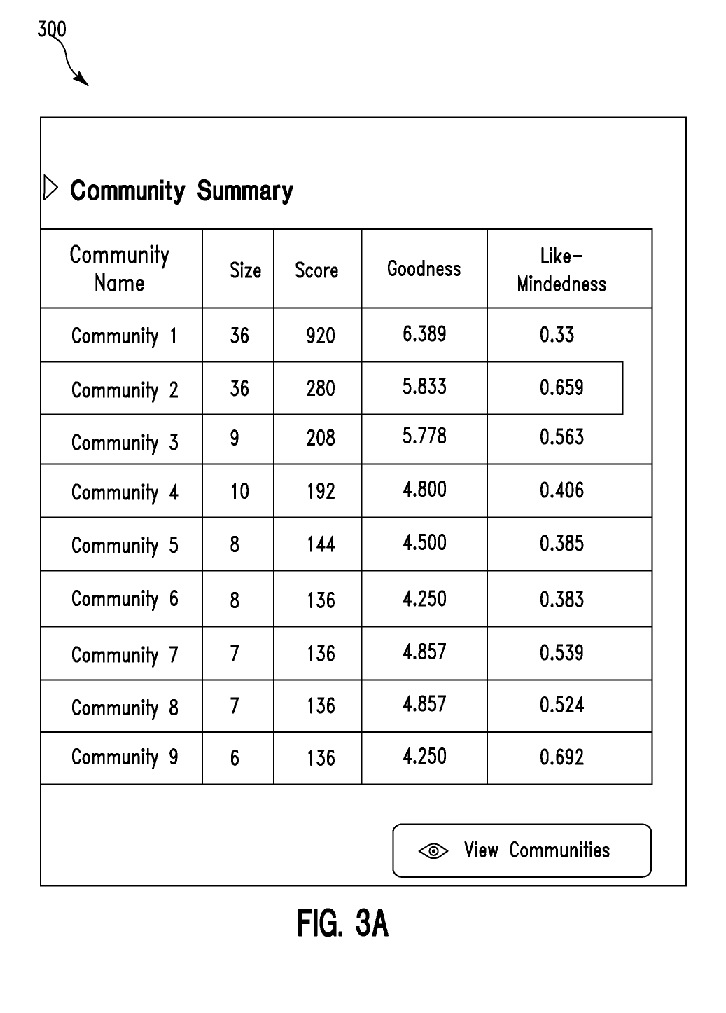

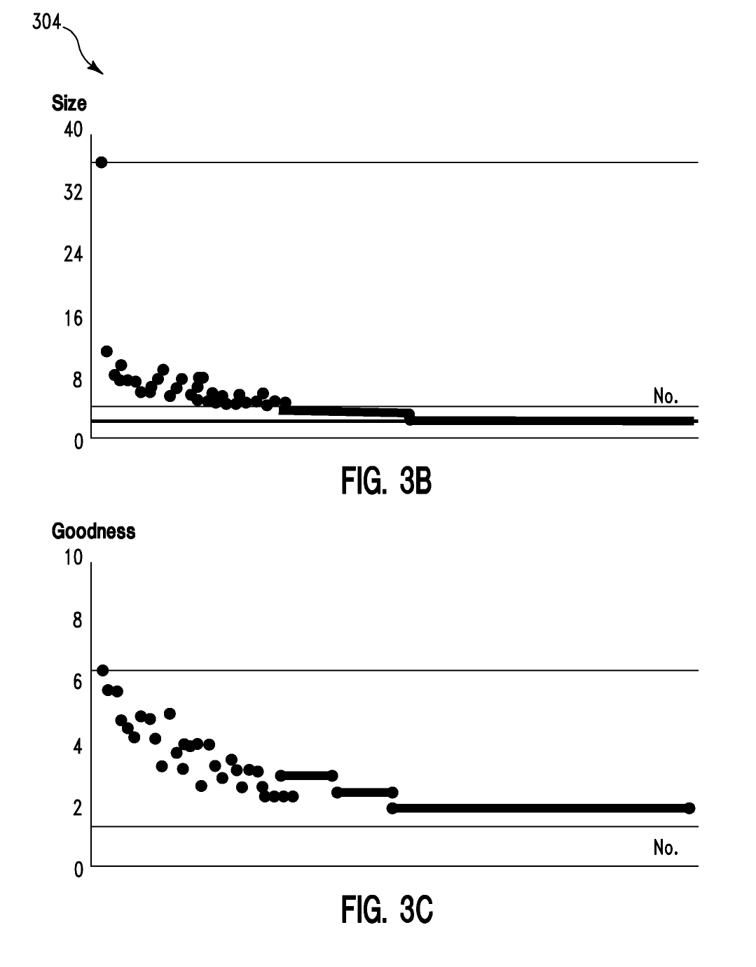

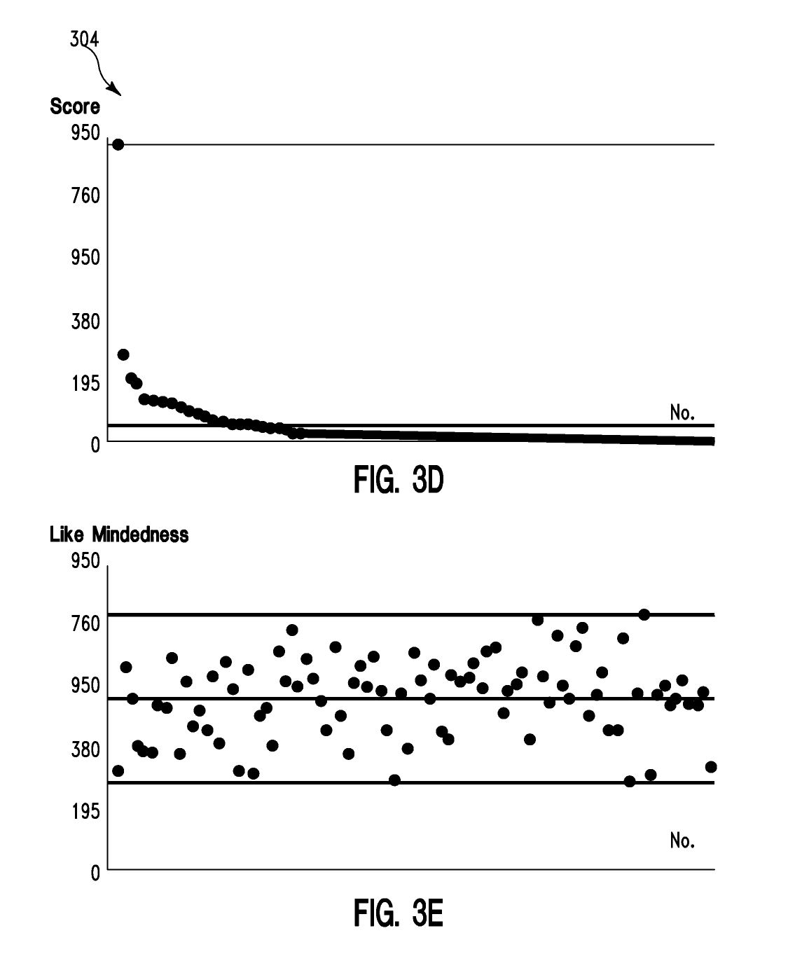

FIGS. 3A-3E illustrate a screen shot 300 enabled by system 2 of FIG. 1 for summarizing like-minded communities, in accordance with embodiments of the present invention. Screenshot 300 illustrates a community summary 302 and a graphical summary 304. Community summary 302 and graphical summary 304 each include a size summary, a score summary, a goodness summary, and a like-mindedness summary.

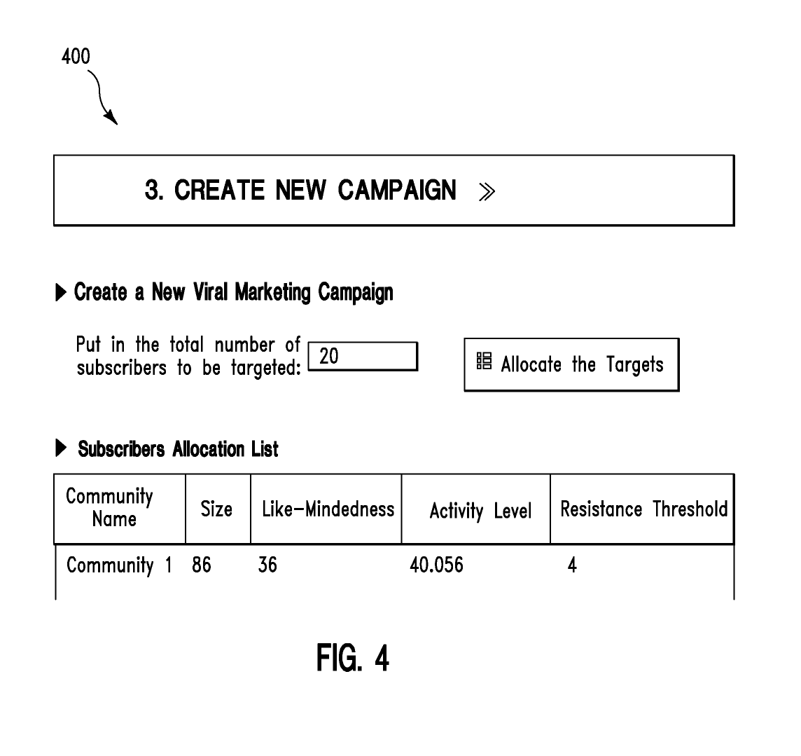

FIG. 4 illustrates a screen shot 400 enabled by system 2 of FIG. 1 for creating a new campaign, in accordance with embodiments of the present invention. Screenshot 400 illustrates a viral marketing campaign such that for a given marketing budget, system 2 generates a recommendation associated with budget allocation.

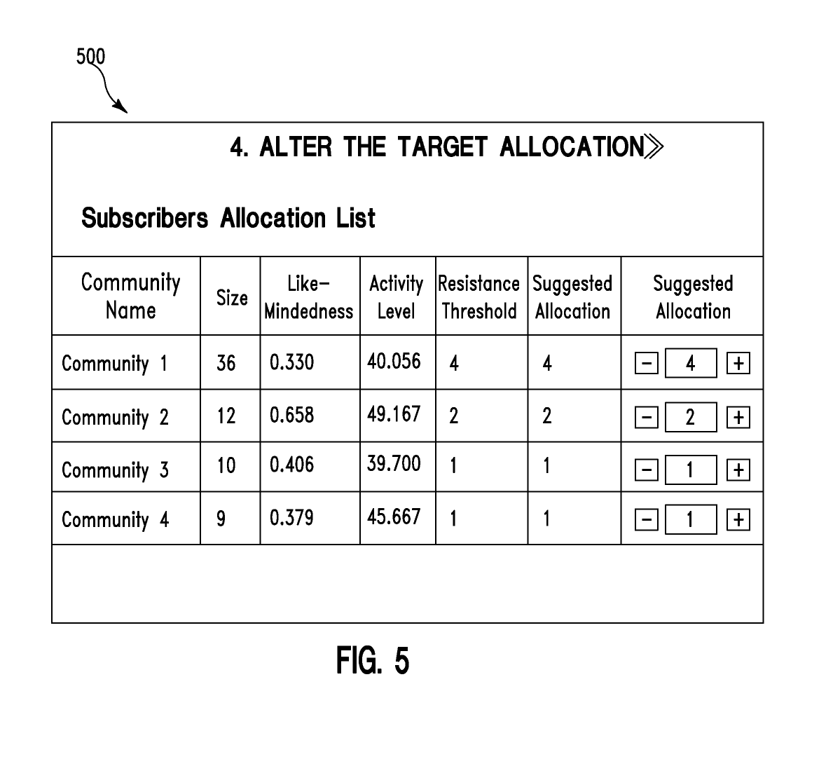

FIG. 5 illustrates a screen shot 400 enabled by system 2 of FIG. 1 for altering a target allocation, in accordance with embodiments of the present invention. Screenshot 400 illustrates an allocation recommendation based on a size, degree of like-mindedness, activity level, and density of the community.

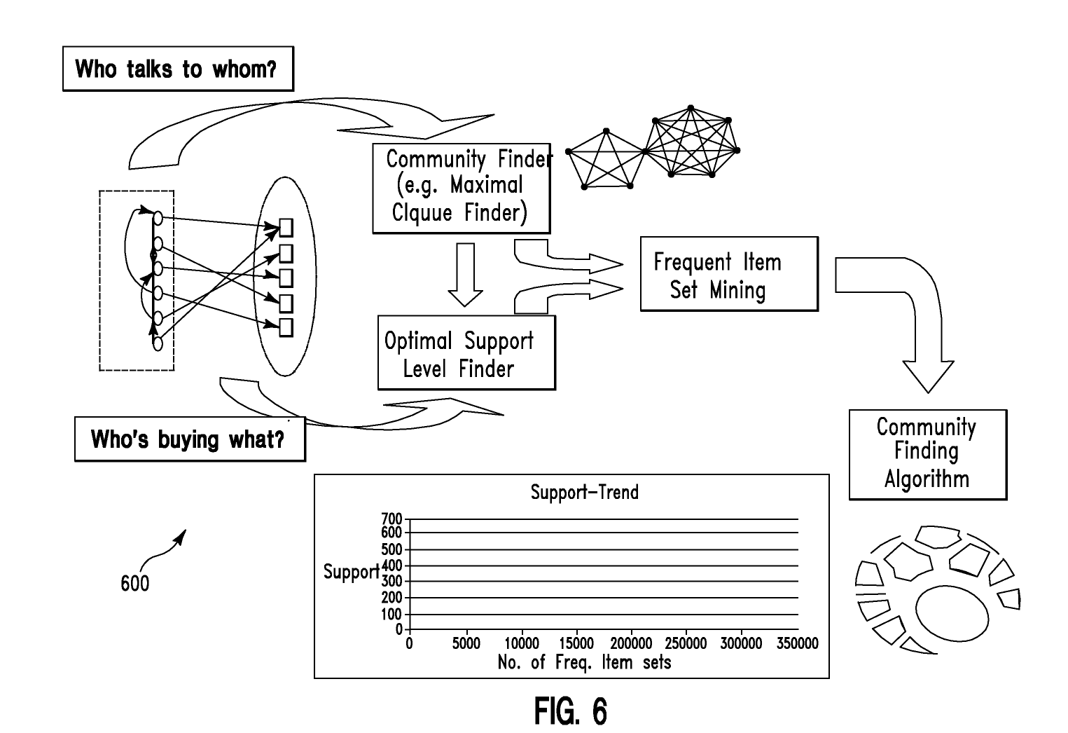

FIG. 6 illustrates a block diagram 600 depicting a process for locating similar (like-minded) communities, in accordance with embodiments of the present invention. In order to locate similar communities, an entire population of individuals is divided into in groups of communities such that the groups are socially well connected. If purchase (or interest/rating) data for the customers are available, communities are located such that they are socially well-connected and have similar purchases (or interests/ratings). The purchase and social interaction data are analyzed together to identify groups that are socially well-connected and are have selected similar choices. Inputs into the system for locating similar (like-minded) communities include: social interaction data and purchase data. The inputs are analyzed to locate purchasing communities for each product or product group by forming a social network for each product group and locating maximal cliques for each of the social networks. Subgroups of people are located such that they purchase many products together and are socially connected. Each community is treated as a transaction and people in the communities are treated as items. The people are divided into communities comprising similarities.

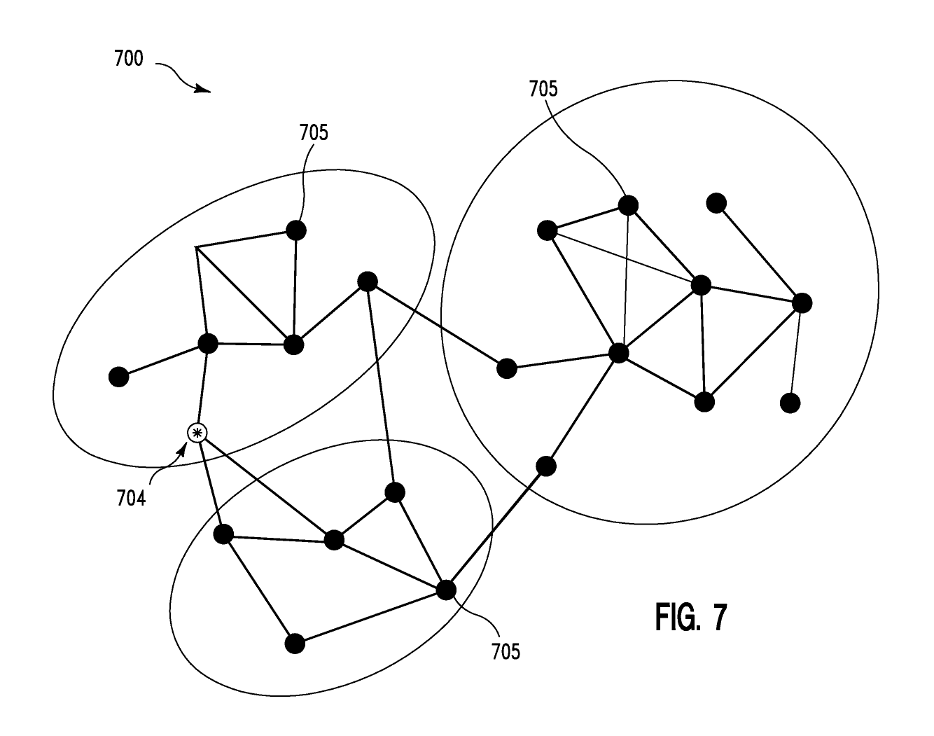

FIG. 7 illustrates a graphical view 700 of similar communities, in accordance with embodiments of the present invention. Node 704 comprises a node that includes less connectivity to its community compared to nodes 705. Node 704 is placed due to a similarity of purchases/interests

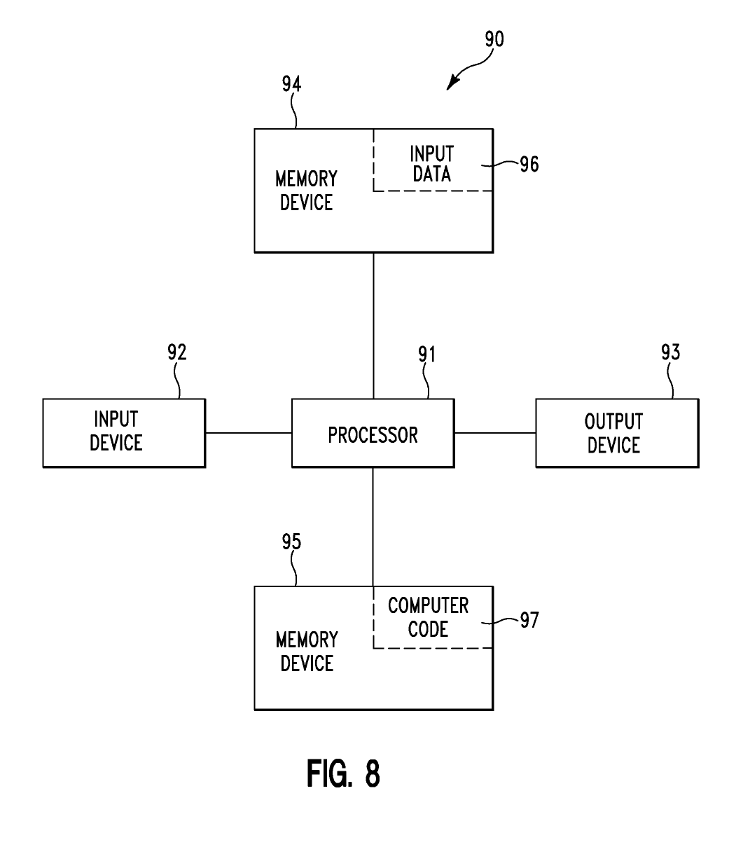

FIG. 8 illustrates a computer apparatus 90 used by system 2 of FIG. 1 for determining initial marketing campaign targets, in accordance with embodiments of the present invention. The computer system 90 includes a processor 91, an input device 92 coupled to the processor 91, an output device 93 coupled to the processor 91, and memory devices 94 and 95 each coupled to the processor 91. The input device 92 may be, inter alia, a keyboard, a mouse, a camera, a touchscreen, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 2) for determining initial marketing campaign targets. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 8) may include the algorithm of FIG. 2 and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

Still yet, any of the components of the present invention could be created, integrated, hosted, maintained, deployed, managed, serviced, etc. by a service supplier who offers to for determine initial marketing campaign targets. Thus the present invention discloses a process for deploying, creating, integrating, hosting, maintaining, and/or integrating computing infrastructure, including integrating computer-readable code into the computer system 90, wherein the code in combination with the computer system 90 is capable of performing a method for determining initial marketing campaign targets. In another embodiment, the invention provides a business method that performs the process steps of the invention on a subscription, advertising, and/or fee basis. That is, a service supplier, such as a Solution Integrator, could offer to determine initial marketing campaign targets. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 8 shows the computer system 90 as a particular configuration of hardware and software, any configuration of hardware and software, as would be known to a person of ordinary skill in the art, may be utilized for the purposes stated supra in conjunction with the particular computer system 90 of FIG. 8. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method comprising:
receiving, by a computer processor of a computing system, a customer list comprising a population of potential customers for a product or service;
receiving, by said computer processor, effort budget data and customer data associated with said potential customers;
dividing, by said computer processor, said potential customers into groups of social communities;
determining, by said computer processor, specified effort criteria associated with said groups of social communities with respect to said product or service;
associating, by said computer processor based on inspection data received from expert individuals with respect to inspecting said social communities, each said specified effort criteria with an associated group of said groups of social communities with respect to said product or service; and
selecting, by said computer processor based on each said specified effort criteria, specified customers from each group of said groups of social communities.

2. The method of claim 1, wherein said groups of social communities comprise similar traits.

3. The method of claim 1, wherein said specified effort criteria is measured in terms of a number of said potential customers for targeting and an amount of a promotion budget allocated to said potential customers.

4. The method of claim 1, wherein said determining said specified effort criteria comprises:
allocating said potential customers into groups of social communities based on specified attributes of said social communities; and
modifying said allocating with respect to a resistance threshold and said effort budget data.

5. The method of claim 4, wherein said specified attributes comprise attributes selected from the group consisting of size attributes, density attributes, like-mindedness attributes, purchase attributes, and interaction level attributes.

6. The method of claim 1, wherein said selecting said specified customers from each said group comprises:
associating a measure of influence associated with specified customers with respect to each other;
associating rewards with each customer of said specified customers;
determining, based on said rewards, gain factors for said specified customers;
selecting a customer of said specified customers associated with a highest gain factor of said gain factors; and
adjusting, based on an influence of said customer, first awards of said awards, wherein said first awards are associated with said first customer.

7. The method of claim 6, wherein said associating said rewards with each said customer is based on mining data associated with a purchase history and profile for each said customer.

8. The method of claim 1, further comprising:
providing at least one support service for at least one of creating, integrating, hosting, maintaining, and deploying computer-readable code in the computing system, said code being executed by the computer processor to implement: said receiving, said dividing, said determining, said associating, and said selecting.

9. A computing system comprising a computer processor coupled to a computer-readable memory unit, said memory unit comprising instructions that when executed by the computer processor implements a method comprising:
receiving, by said computer processor, a customer list comprising a population of potential customers for a product or service;
receiving, by said computer processor, effort budget data and customer data associated with said potential customers;
dividing, by said computer processor, said potential customers into groups of social communities;
determining, by said computer processor, specified effort criteria associated with said groups of social communities with respect to said product or service;
associating, by said computer processor based on inspection data received from expert individuals with respect to inspecting said social communities, each said specified effort criteria with an associated group of said groups of social communities with respect to said product or service; and
selecting, by said computer processor based on each said specified effort criteria, specified customers from each group of said groups of social communities.

10. The computing system of claim 9, wherein said groups of social communities comprise similar traits.

11. The computing system of claim 9, wherein said specified effort criteria is measured in terms of a number of said potential customers for targeting and an amount of a promotion budget allocated to said potential customers.

12. The computing system of claim 9, wherein said determining said specified effort criteria comprises:
allocating said potential customers into groups of social communities based on specified attributes of said social communities; and
modifying said allocating with respect to a resistance threshold and said effort budget data.

13. The computing system of claim 12, wherein said specified attributes comprise attributes selected from the group consisting of size attributes, density attributes, like-mindedness attributes, purchase attributes, and interaction level attributes.

14. The computing system of claim 9, wherein said selecting said specified customers from each said group comprises:
associating a measure of influence associated with specified customers with respect to each other;
associating rewards with each customer of said specified customers;
determining, based on said rewards, gain factors for said specified customers;
selecting a customer of said specified customers associated with a highest gain factor of said gain factors; and
adjusting, based on an influence of said customer, first awards of said awards, wherein said first awards are associated with said first customer.

15. The computing system of claim 14, wherein said associating said rewards with each said customer is based on mining data associated with a purchase history and profile for each said customer.

16. A computer program product, comprising a computer readable hardware storage device storing a computer readable program code, said computer readable program code comprising an algorithm that when executed by a computer processor of a computer system implements a method, said method comprising:
receiving, by said computer processor, a customer list comprising a population of potential customers for a product or service;
receiving, by said computer processor, effort budget data and customer data associated with said potential customers;
dividing, by said computer processor, said potential customers into groups of social communities;
determining, by said computer processor, specified effort criteria associated with said groups of social communities with respect to said product or service;
associating, by said computer processor based on inspection data received from expert individuals with respect to inspecting said social communities, each said specified effort criteria with an associated group of said groups of social communities with respect to said product or service; and
selecting, by said computer processor based on each said specified effort criteria, specified customers from each group of said groups of social communities.

17. The computer program product of claim 16, wherein said groups of social communities comprise similar traits.

18. The computer program product of claim 16, wherein said specified effort criteria is measured in terms of a number of said potential customers for targeting and an amount of a promotion budget allocated to said potential customers.

19. The computer program product of claim 16, wherein said determining said specified effort criteria comprises:
allocating said potential customers into groups of social communities based on specified attributes of said social communities; and
modifying said allocating with respect to a resistance threshold and said effort budget data.

20. The computer program product of claim 19, wherein said specified attributes comprise attributes selected from the group consisting of size attributes, density attributes, like-mindedness attributes, purchase attributes, and interaction level attributes.
